(19) United States
(12) Patent Application Publication
(10) Pub. No.: US 2011/0180219 A1
(43) Pub. Date: Jul. 28, 2011

(54) REPLACEABLE SHADE SYSTEM AND METHOD OF USING SAME

(75) Inventors: Tyrone John Anthony Pereira, San Diego, CA (US); James Evan McCoy, Menifee, CA (US)

(73) Assignee: Nutmeg Industries, Inc., d.b.a. Roll-A-Shade

(21) Appl. No.: 12/975,299

(22) Filed: Dec. 21, 2010

Related U.S. Application Data
(60) Provisional application No. 61/297,768, filed on Jan. 24, 2010.

(51) Int. Cl. E06B 9/24

(52) U.S. Cl. 160/89; 160/405

(57) ABSTRACT

A replaceable shade system and method of using it according to certain embodiments of the invention may include at least one at least one replaceable shade, a permanent shade, and a means for attaching the at least one replaceable shade to the permanent shade. The replaceable shade system may further include an image applied to the at least one replaceable shade.

### RELATED APPLICATION

This application is related to Provisional Application Ser. No. 61/297,768, filed Jan. 24, 2010 and entitled REPLACEABLE SHADE SYSTEM AND METHOD OF USING SAME. Priority is claimed under this provisional, which is incorporated by reference in its entirety.

### FIELD OF THE INVENTION

The present invention relates in general to a novel replaceable shade system and method of using it.

### BACKGROUND ART

This section describes the background of the disclosed embodiment of the present invention. There is no intention, either express or implied, that the background art discussed in this section legally constitutes prior art.

Many business owners use their windows to display advertisements for their products and/or services. At the same time, however, business owners need to block sunlight, heat, and damaging ultraviolet radiation from entering their windows.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of a replaceable shade system, which is constructed according to an embodiment of the present invention, with a replaceable shade attached to a permanent shade;

FIG. 2 is a pictorial view of the replaceable shade system of FIG. 1, wherein the replaceable shade is shown to be partially detached from the permanent shade;

FIG. 3 is a pictorial view of a replaceable shade system, which is constructed according to another embodiment of the invention, with a replaceable shade attached to a permanent shade that is attached to a tube;

FIG. 4 is a pictorial view of the replaceable shade system of FIG. 3, with a replaceable shade attached to a permanent shade that is attached to a tube, wherein the replaceable shade is shown to be partially detached from the permanent shade;

FIGS. 5 is a pictorial view of a replaceable shade system, which is constructed according to another embodiment of the invention, with a replaceable shade attached to a tube;

FIG. 6 is a pictorial view of a replaceable shade system, which is constructed according to another embodiment of the invention;

FIG. 7 is a pictorial view of a replaceable shade system, which is constructed according to another embodiment of the invention, with an image applied to the replaceable shade;

FIG. 8 is a pictorial view of a replaceable shade system, which is constructed according to another embodiment of the invention, with the replaceable shade attached to a permanent shade;

FIG. 9 is a pictorial view of the replaceable shade system of FIG. 8, wherein the replaceable shade is being attached to the permanent shade by a tongue-in-groove type attachment means by sliding the replaceable shade into place on the permanent shade;

FIG. 10 is a partial side view of the tongue-in-groove type attachment means of the replaceable shade system shown in FIG. 8 and FIG. 9;

FIG. 11 is a pictorial view of a replaceable shade system, which is constructed according to another embodiment of the invention, with the replaceable shade attached to a permanent shade by a zipper-type attachment means;

FIG. 12 is a pictorial view of the replaceable shade system of FIG. 11, wherein the replaceable shade is shown to be partially detached from the permanent shade;

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A replaceable shade system and method of using it according to certain embodiments of the invention may include at least one replaceable shade, a permanent shade, and a means for attaching the at least one replaceable shade to the permanent shade.

According to certain embodiments of the invention, the means for attaching the at least one replaceable shade to the permanent shade may include, but is not limited to, any type of recloseable fastener, such as snaps, zippers, tongue-in-groove type of fastener, 3M™ Dual Lock™, 3M™ Scotchmate™, Velcro™.

In other embodiments of the invention, the replaceable shade system may include at least one replaceable shade and a means for attaching the replaceable shade to the area to be covered by the shade, including, but not limited to a window.

According to certain embodiments of the invention, the means for attaching the at least one replaceable shade to the area to be covered may include, but is not limited to, any type of recloseable fastener, such as snaps, zippers, tongue-in-groove type of fastener, 3M™ Dual Lock™, 3M™ Scotchmate™, Velcro™.

According to certain embodiments of the invention, the user of the replaceable shade system may attach and remove replaceable shades from the replaceable shade system as needed. The various replaceable shades of the replaceable shade system may have various images applied to the surface of the replaceable shades, allowing the user to change which image is displayed by changing the replaceable shade that is attached to the replaceable shade system.

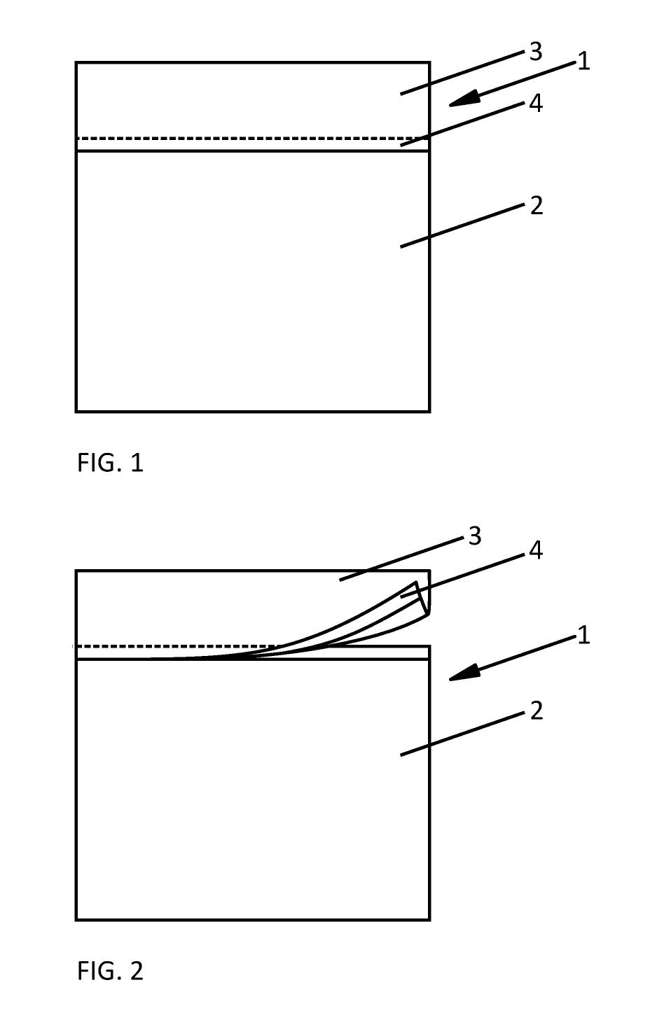

Referring now to the figures, FIG. 1 shows an embodiment of the replaceable shade system 1 of the invention. This replaceable shade system includes at least one replaceable shade 2, a permanent shade 3, and a means for attaching the at least one replaceable shade to the permanent shade 4.

FIG. 2 depicts the replaceable shade system 1 of FIG. 1, wherein the at least one replaceable shade 2 is shown to be partially detached from the permanent shade 3.

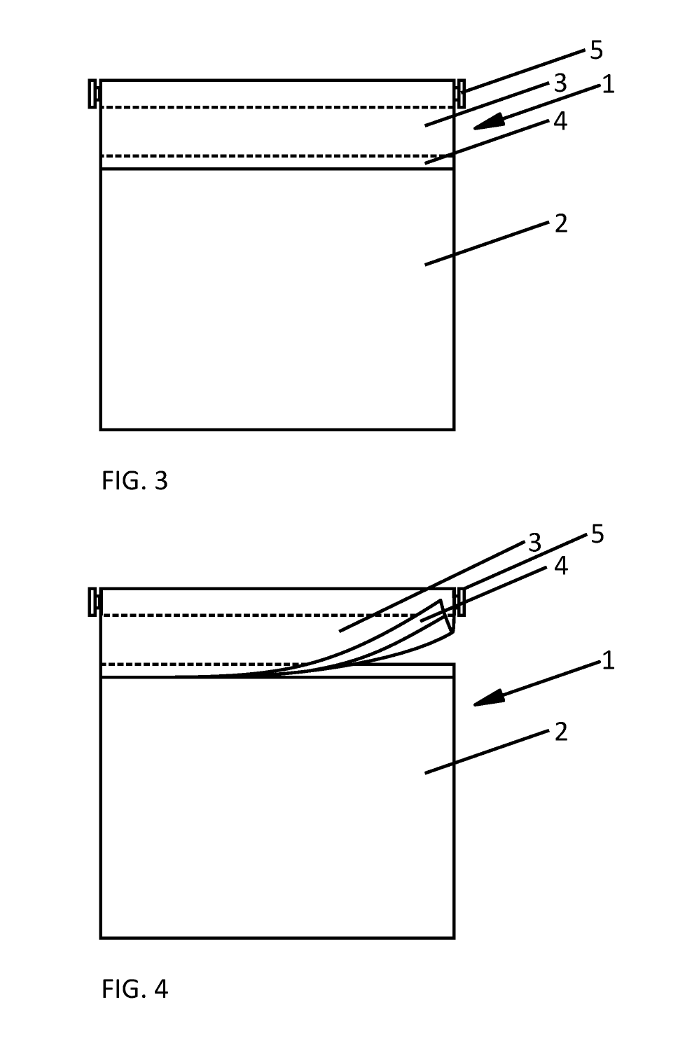

FIG. 3 shows an embodiment of the replaceable shade system 1 of the invention, wherein the replaceable shade system 1 includes at least one replaceable shade 2, a permanent shade 3, a means for attaching the at least one replaceable shade to the permanent shade 4, and a tube 5.

FIG. 4 depicts the replaceable shade system 1 of FIG. 3, wherein the at least one replaceable shade 2 is shown to be partially detached from the permanent shade 3.

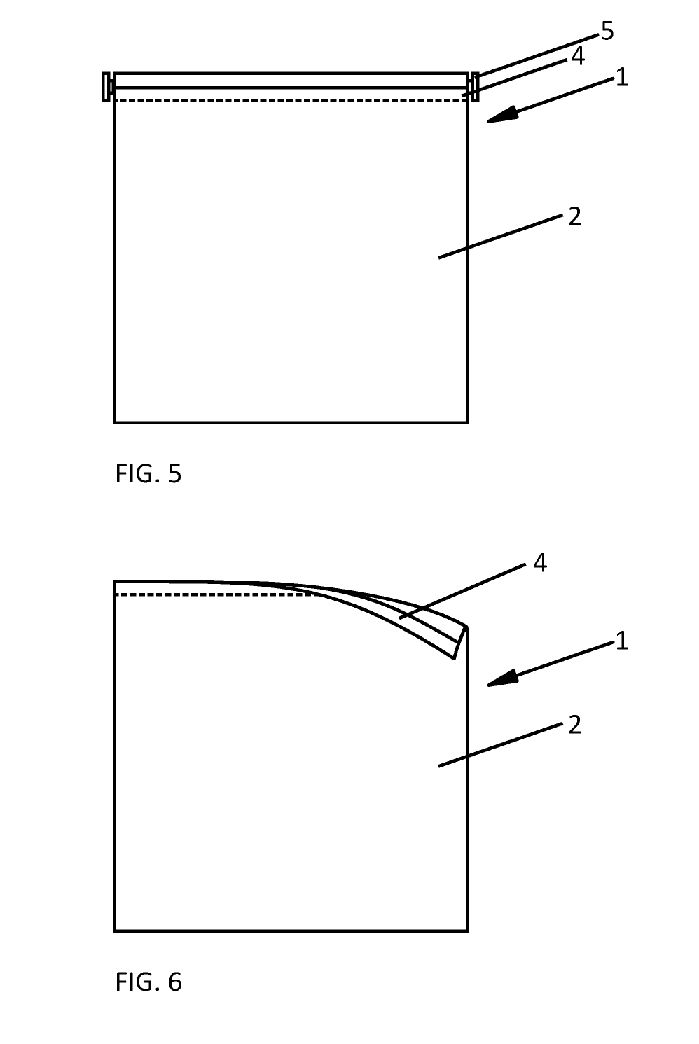

FIG. 5 shows an embodiment of the replaceable shade system 1 of the invention, wherein the replaceable shade system 1 includes at least one replaceable shade 2, a means for attaching the at least one replaceable shade 4, and a tube 5 to which the at least one replaceable shade is attached to.

FIG. 6 shows an embodiment of the replaceable shade system 1 of the invention, wherein the replaceable shade system 1 includes at least one replaceable shade 2 and a means for attaching the at least one replaceable shade 4 to the area to be covered by the shade.

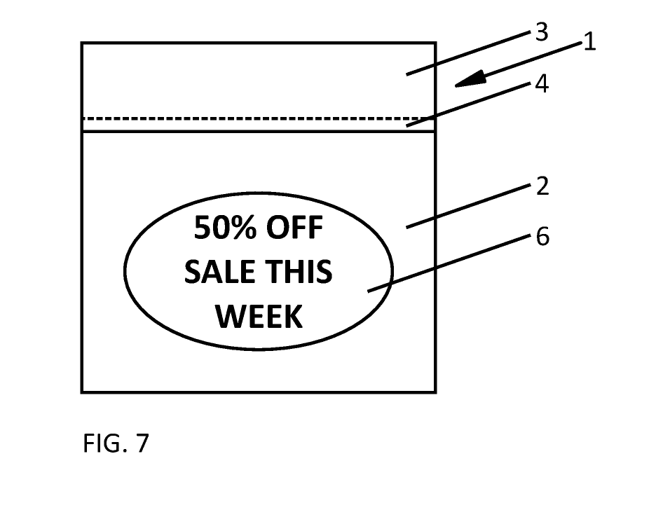

FIG. 7 depicts the replaceable shade system 1 of FIG. 1, wherein the at least one replaceable shade 2 is shown with an image 6 applied to the at least one replaceable shade 2.

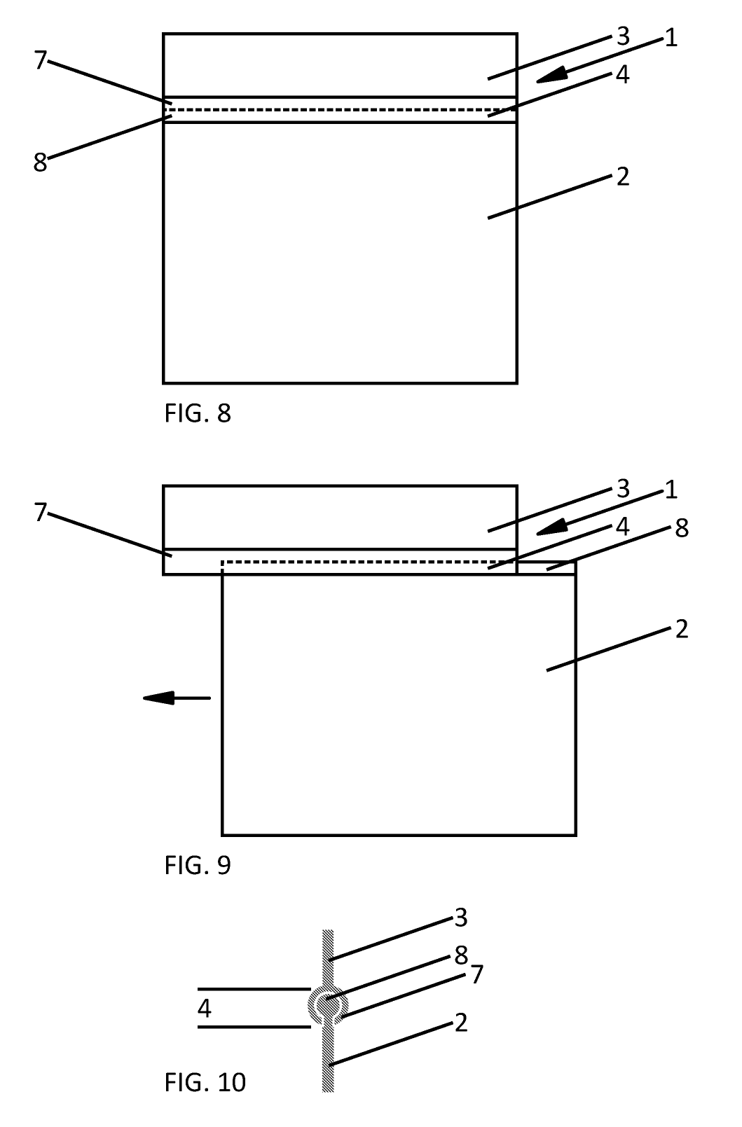

FIG. 8 shows an embodiment of the replaceable shade system 1 of the invention, wherein the replaceable shade system 1 includes at least one replaceable shade 2, a permanent shade 3, and a means for attaching the at least one replaceable shade to the permanent shade 4.

FIG. 9 depicts the replaceable shade system 1 of FIG. 8, wherein the replaceable shade 2 is being attached to the permanent shade 3 by a tongue-in-groove type attachment means 4 by sliding the replaceable shade 3 into place on the permanent shade 4.

FIG. 10 shows a partial side view of the tongue-in-groove type attachment means 4 of the replaceable shade system 1 shown in FIG. 8 and FIG. 9. In this embodiment of the invention, the tongue portion 8 of the tongue-in-groove type attachment means 4 fits within the groove portion 7 of the tongue-in-groove type attachment means 4. In this figure the tongue portion 8 is attached to the replaceable shade 2 and the groove portion 7 is attached to the permanent shade 3. However, in other embodiments, not shown in the figures, the tongue portion 8 may be attached to the permanent shade 3 and the groove portion 7 may be attached to the replaceable shade 2.

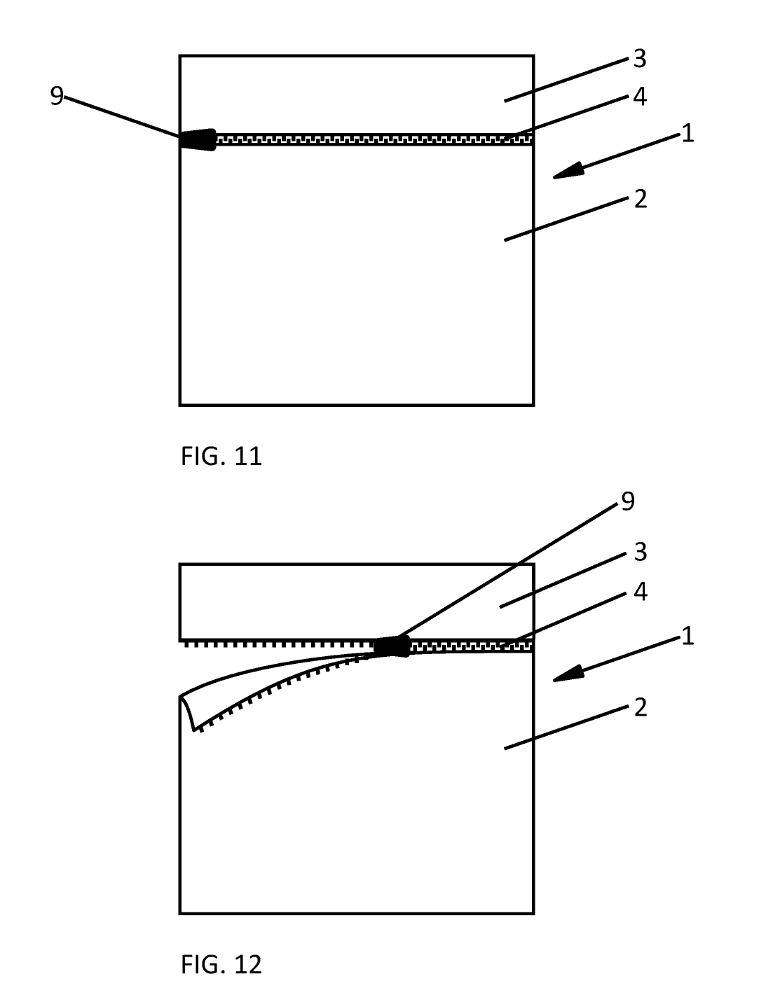

FIG. 11 shows an embodiment of the replaceable shade system 1 of the invention, wherein the replaceable shade system 1 includes at least one replaceable shade 2, a permanent shade 3, and a means for attaching 4 the at least one replaceable shade 2 to the permanent shade 2. In this embodiment, the attachment means 4 is a zipper-type attachment means, and the replaceable shade 2 is attached to the permanent shade 3 by moving the zipper pull 9 along the zipper type attachment means 4.

FIG. 12 depicts the replaceable shade system of FIG. 11, wherein the at least one replaceable shade 2 is shown to be partially detached from the permanent shade 3. The zipper-type attachment means 4 is shown partially open.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

What is claimed is:

1. A replaceable shade system, said replaceable shade system comprising:
at least one replaceable shade;
a permanent shade; and
at least one means for attaching said at least one replaceable shade to said permanent shade.

2. The replaceable shade system of claim 1, wherein said at least one means for attaching said at least replaceable shade comprises a recloseable fastener.

3. The replaceable shade system of claim 2, wherein said recloseable fastener is a fastener selected from the group consisting of snaps, zippers, tongue-in-groove type of fasteners, 3M™ Dual Lock™, 3M™ Scotchmate™, and Velcro™.

4. The replaceable shade system of claim 1, wherein said replaceable shade system further comprises a tube.

5. The replaceable shade system of claim 1, wherein said replaceable shade system further comprises an image applied to said at least one replaceable shade.

6. A method of using the replaceable shade system of claim 1, wherein said method comprises:
attaching one of said at least one replaceable shade to the permanent shade;
detaching said at least one replaceable shade from the permanent shade; and
attaching another of said at least one replaceable shade to the permanent shade.
